(19) United States
(12) Patent Application Publication
(10) Pub. No.: US 2025/0112749 A1
(43) Pub. Date: Apr. 3, 2025

(54) COMMUNICATION APPARATUS, CONTROL METHOD, AND STORAGE MEDIUM

(71) Applicant: CANON KABUSHIKI KAISHA, Tokyo (JP)

(72) Inventors: MITSUYOSHI YUKAWA, Kanagawa (JP); YUSUKE OSHIKAWA, Kanagawa (JP)

(21) Appl. No.: 18/980,697

(22) Filed: Dec. 13, 2024

Related U.S. Application Data
(63) Continuation of application No. PCT/JP2023/021543, filed on Jun. 9, 2023.

(30) Foreign Application Priority Data
Jul. 1, 2022 (JP) 2022-107399

(51) Int. Cl. H04L 5/00; H04W 72/0453; H04W 84/12

(52) U.S. Cl. CPC H04L 5/0053; H04W 72/0453; H04W 84/12

(57) ABSTRACT

In a case where a bandwidth of 640 MHz is used, a high reliability trigger-based physical layer protocol data unit (HR TB PPDU) is transmitted that includes a universal signal (U-SIG) including a spatial reuse 1 subfield indicating information regarding spatial reuse in a first 320 MHz subband and a spatial reuse 2 subfield indicating information regarding spatial reuse in a second 320 MHz subband.

### CROSS-REFERENCE TO RELATED APPLICATIONS

This application is a Continuation of International Patent Application No. PCT/JP2023/021543, filed Jun. 9, 2023, which claims the benefit of Japanese Patent Application No. 2022-107399, filed Jul. 1, 2022, both of which are hereby incorporated by reference herein in their entirety.

### BACKGROUND OF THE INVENTION

### Field of the Invention

The present invention relates to a communication apparatus that communicates data by wireless communication.

### Background Art

The Institute of Electrical and Electronics Engineers (IEEE) 802.11 series standards are known as wireless local area network (WLAN) communication standards formulated by the IEEE. The IEEE 802.11 series standards include the IEEE 802.11a/b/g/n/ac/ax/be standards.

According to PTL 1, it is discussed that wireless communication using orthogonal frequency division multiple access (OFDMA) is executed in the IEEE 802.11ax standard. In the IEEE 802.11ax standard, high peak throughput is achieved by executing wireless communication using OFDMA. Further, into the IEEE 802.11ax standard, a function referred to as spatial reuse has been introduced, which understands a propagation state of another wireless communication and allows simultaneous communication if it does not affect communication. Furthermore, in the IEEE 802.11be standard, which is a successor standard to the IEEE 802.11ax standard, a radio wave bandwidth is extended to 320 MHz in order to improve throughput, and the spatial reuse function is also extended to 320 MHz.

The IEEE considers extension of the radio wave bandwidth beyond 320 MHz in order to further improve throughput.

### CITATION LIST

### Patent Literature

PTL 1: Japanese Patent Application Laid-Open No. 2018-50133

However, the radio wave bandwidth is limited to a maximum of 320 MHz until the IEEE 802.11be standard, so that there is no appropriate frame structure that can communicate information regarding spatial reuse if communication is performed using a bandwidth exceeding 320 MHz, such as 640 MHz.

### SUMMARY OF THE INVENTION

The present invention is directed to enabling a communication apparatus that can communicate using a wider bandwidth to appropriately communicate information regarding spatial reuse.

A communication apparatus includes a transmission unit configured to transmit a trigger-based (TB) physical layer protocol data unit (PPDU) including a legacy-short training field (L-STF), a legacy-long training field (L-LTF) following the L-STF, a legacy-signal (L-SIG) following the L-LTF, a universal signal (U-SIG) which is a field following the L-SIG and includes a spatial reuse 1 subfield and a spatial reuse 2 subfield, and in which in a case where the communication apparatus uses a bandwidth of 640 MHz, the spatial reuse 1 subfield indicates information regarding spatial reuse in a first 320 MHz subband and the spatial reuse 2 subfield indicates information regarding spatial reuse in a second 320 MHz subband, a second short training field (STF) following the U-SIG; and a second long training field (LTF) following the second STF.

Further features of the present invention will become apparent from the following description of exemplary embodiments with reference to the attached drawings.

### BRIEF DESCRIPTION OF THE DRAWINGS

FIG. 1 illustrates a configuration example of a wireless communication system according to an exemplary embodiment.

FIG. 2 illustrates a hardware configuration of a communication apparatus.

FIG. 3 illustrates an example of a physical layer (PHY) frame structure of a high reliability trigger-based physical layer protocol data unit (HR TB PPDU) transmitted by the communication apparatus.

FIG. 4 illustrates an example of meanings corresponding to values in each subfield of spatial reuse 1 and 2 of a universal signal (U-SIG).

FIG. 5 illustrates an example of a relationship between the subfields of the spatial reuse 1 and 2 of U-SIG-1 and subbands for each bandwidth to be used.

FIG. 6 illustrates an example of a configuration of a trigger frame.

### DESCRIPTION OF THE EMBODIMENTS

The attached drawings are incorporated in and configure a part of the specification, illustrate exemplary embodiments of the present invention, and are used to illustrate the principles of the present invention together with descriptions in the specification.

The exemplary embodiments of the present invention are described in detail below with reference to the attached drawings. Configurations described in the following exemplary embodiments are merely examples, and the present invention is not limited to the configurations illustrated in the drawings.

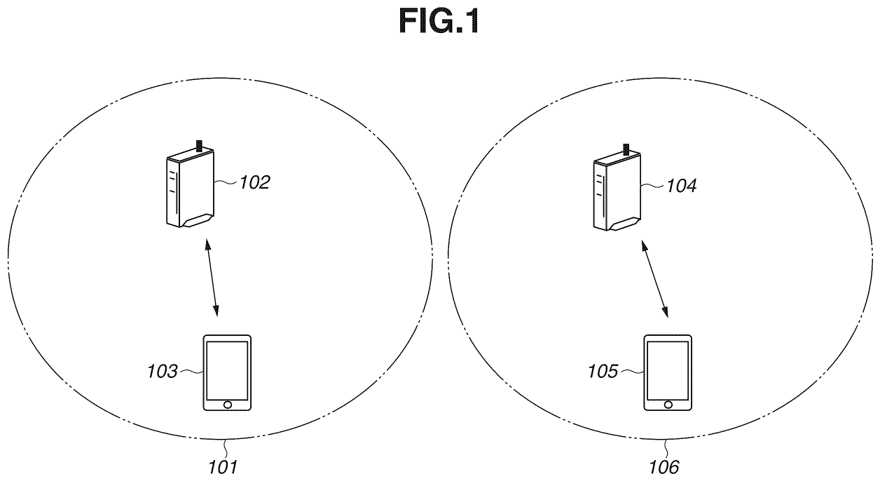

FIG. 1 illustrates a configuration example of a wireless communication system according to the present exemplary embodiment. A basic service set (BSS) 101 is a network managed by a communication apparatus 102 that is as an access point (AP). A communication apparatus 103 is a station (STA) that participates in the BSS 101. A BSS 106 is a network managed by a communication apparatus 104 that is an AP, and a communication apparatus 105 participates in the BSS 106.

Each communication apparatus is configured to be able to execute wireless communication conforming to a successor standard to the Institute of Electrical and Electronics Engineers (IEEE) 802.11be standard, which targets a maximum transmission speed of 46.08 Gbps, and a successor standard that targets the maximum transmission speed of 90 Gbps to 100 Gbps or more. The successor standard to the IEEE 802.11be standard sets support for highly reliable communication and low latency communication as a new target to be achieved. Based on the above, according to the present exemplary embodiment, a successor standard to the IEEE 802.11be standard, which targets the maximum transmission speed of 90 Gbps to 100 Gbps or more, is tentatively named IEEE 802.11 high reliability (HR).

The name IEEE 802.11 HR is set for convenience sake based on a target to be achieved in the successor standard and a key feature thereof, and thus may be a different name once the standard is finalized. Meanwhile, it should be noted that the specification and the appended claims are essentially applicable to all successor standards to the IEEE 802.11be standard that can support wireless communication. Further, each communication apparatus can communicate in 2.4 GHz, 5 GHZ, and 6 GHz frequency bandwidths. Furthermore, each communication apparatus can communicate using bandwidths of 20 MHz, 40 MHz, 80 MHz, 160 MHz, 320 MHz, 480 MHz, 560 MHz and 640 MHz.

The communication apparatuses 102 to 105 execute orthogonal frequency division multiple access (OFDMA) communication conforming to the IEEE 802.11 HR standard and thus can realize multi user (MU) communication that multiplexes signals from a plurality of users. In OFDMA communication, a part of a divided frequency band (a resource unit, (RU)) is allocated to each STA so as not to overlap with each other, and carrier waves of each STA are orthogonal to each other. Thus, the AP can communicate with a plurality of STAs in parallel.

The communication apparatuses 102 to 105 can also realize MU communication using multi user multiple-input and multiple-output (MU MIMO) communication. In this case, the communication apparatus 102 includes a plurality of antennas and can realize simultaneous communication with the plurality of STAs by allocating one or more antennas to each of the other communication apparatuses. The communication apparatus 102 can simultaneously transmit radio waves to the plurality of STAs by adjusting the radio waves transmitted to each of the communication apparatuses 103 to 105 not to interfere with each other.

The communication apparatuses 102 to 105 have a spatial reuse function of understanding a propagation state of another wireless communication and allowing simultaneous communication if it does not affect communication. There are two types of spatial reuse: overlapping basic service set packet detect (OBSS PD)-based and parameterized spatial reuse (PSR)-based. In OBSS PD-based, the communication apparatus performs control to change a carrier sense threshold value for a received packet based on whether the packet is from the BSS to which the communication apparatus itself belongs or from other BSS (OBSS) to which the communication apparatus itself does not belong. Specifically, in a case of the packet from the other BSS to which the communication apparatus itself does not belong, the communication apparatus performs control to increase the carrier sense threshold value. Accordingly, the communication apparatus can execute its own communication even in a case where a packet from the other BSS to which the communication apparatus itself does not belong is communicated, in which communication suppression has conventionally been executed. In PSR-based, the communication apparatus performs transmission from itself using transmission power that does not affect a reception operation of the other BSS to which the communication apparatus itself does not belong. In PSR-based, only if the other BSS to which the communication apparatus itself does not belong permits the execution, the execution is possible. Accordingly, the communication apparatus can transmit data even in a period in which an AP in the other BSS receives data.

It is described that the communication apparatuses 102 to 105 conform to the IEEE 802.11 HR standard, but, in addition to it, they may conform to a legacy standard that predates the IEEE 802.11 HR standard. Specifically, the communication apparatuses 102 to 105 may conform to at least any one of the IEEE 802.11a/b/g/n/ac/ax/be standards. In addition to the IEEE 802.11 series standards, the communication apparatuses 102 to 105 may conform to other communication standards, such as Bluetooth®, near field communication (NFC), ultra wide band (UWB), ZigBee, and multiband OFDM alliance (MBOA). UWB includes Wireless Universal Serial Bus (USB), Wireless 1394, and Wireless Networks (WiNET). The communication apparatuses 102 to 105 may also conform to a communication standard for wired communication such as wired local area network (LAN).

Specific examples of the communication apparatuses 102 and 104 include, but are not limited to, a wireless LAN router and a personal computer (PC). Further, the communication apparatuses 102 and 104 may be information processing apparatuses, such as wireless chips, that can execute wireless communication conforming to the IEEE 802.11 HR standard. Specific examples of the communication apparatuses 103 and 105 include, but are not limited to, a camera, a tablet, a smartphone, a PC, a mobile phone, a video camera, and a projector. Further, the communication apparatuses 103 and 105 may be information processing apparatuses, such as wireless chips, that can execute wireless communication conforming to the IEEE 802.11 HR standard. Each BSS in FIG. 1 is a network configured with one AP and one STA, but the number of APs and STAs are not limited to this. An information processing apparatus such as a wireless chip includes an antenna for transmitting a generated signal.

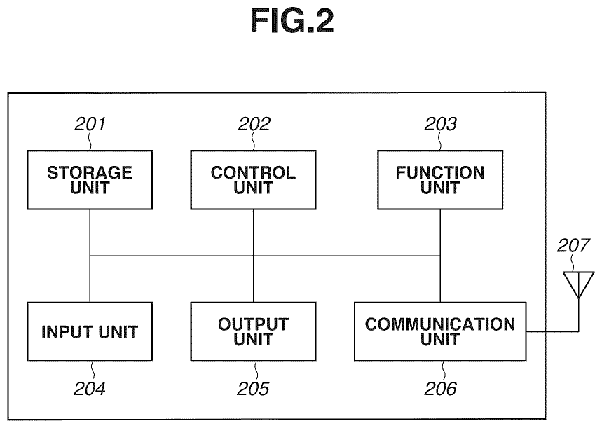

FIG. 2 illustrates a hardware configuration of the communication apparatus 103 according to the present invention. The communication apparatus 103 includes a storage unit 201, a control unit 202, a function unit 203, an input unit 204, an output unit 205, a communication unit 206, and an antenna 207.

The storage unit 201 is configured with memories such as a read-only memory (ROM) and a random access memory (RAM) and stores various types of information such as a computer program for performing various operations described below and a communication parameter for wireless communication. As the storage unit 201, in addition to memories such as a ROM and a RAM, storage media such as a flexible disk, a hard disk, an optical disk, a magneto-optical disk, a compact disk (CD)-ROM, a CD-readable (R), a magnetic tape, a non-volatile memory card, and a digital versatile disk (DVD) may also be used. Further, the storage unit 201 may include a plurality of memories.

The control unit 202 is configured with one or more processors, such as a central processing unit (CPU) and a micro processing unit (MPU), and controls the entire communication apparatus 103 by executing a computer program stored in the storage unit 201. The control unit 202 may control the entire communication apparatus 103 in cooperation with the computer program stored in the storage unit 201 and an operating system (OS). The control unit 202 generates data and a signal to be transmitted in communication with the other communication apparatus. The control unit 202 may include a plurality of processors such as multi-core processors and control the entire communication apparatus 103 by the plurality of processors.

The control unit 202 controls the function unit 203 to execute predetermined processing such as wireless communication, image capturing, printing, and projecting. The function unit 203 is hardware that enables the communication apparatus 103 to execute predetermined processing.

The input unit 204 receives various operations from a user. The output unit 205 performs various outputs to the user via a monitor screen and a loudspeaker. Here, the output by the output unit 205 may be display on the monitor screen, a sound output from the loudspeaker, a vibration output, and the like. Both the input unit 204 and the output unit 205 may be realized in a single module such as a touch panel. Further, the input unit 204 and the output unit 205 may each be integrated with or separated from the communication apparatus 103.

The communication unit 206 controls wireless communication conforming to the IEEE 802.11 HR standard. The communication unit 206 may also control wireless communication conforming to the other IEEE 802.11 series standards in addition to the IEEE 802.11 HR standard and may control wired communication such as a wired LAN. The communication unit 206 controls the antenna 207 to transmit and receive radio signals for wireless communication generated by the control unit 202. In a case where the communication apparatus 103 conforms to the NFC standard, the Bluetooth® standard, and the like in addition to the IEEE 802.11 HR standard, the communication apparatus 103 may control wireless communication conforming to these communication standards. Further, in a case where the communication apparatus 103 can execute wireless communication conforming to a plurality of communication standards, the communication apparatus 103 may be configured to include the communication units 206 and the antennas 207 that individually correspond to the respective communication standards. The communication apparatus 103 communicates data such as image data, document data, and video data with the communication apparatus 102 via the communication unit 206. The antenna 207 may be configured as a separate unit from the communication unit 206, or may be configured together with the communication unit 206 as a single module.

The communication apparatuses 102, 104, and 105 may also have a hardware configuration similar to that of the communication apparatus 103.

Next, PSR-based spatial reuse (SR) is described with reference to FIG. 1.

The communication apparatus 102 communicates a trigger frame (TF), which is a control signal that prompts transmission of an uplink signal (for example, an OFDMA signal), to the communication apparatus 103 participating in the BSS 101. In a case where the TF transmitted by the communication apparatus 102 includes a value from 1 to 14 in an uplink (UL) spatial reuse field of a common info field, a physical layer protocol data unit (PPDU) including the TF is referred to as a parameterized spatial reuse reception (PSRR) PPDU. The communication apparatus 102 generates and transmits a PSRR PPDU that includes information regarding spatial reuse in the TF to be transmitted and thus can notify a peripheral apparatus of the information regarding spatial reuse.

The communication apparatus 103 transmits a high reliability trigger-based (HR TB) PPDU as a response to the received TF. The communication apparatus 103 includes the information regarding spatial reuse in the HR TB PPDU to be transmitted and thus can notify the peripheral apparatus of the information regarding spatial reuse. The details of the HR TB PPDU are described below.

In the PSR-based SR, the communication apparatus acquires an upper limit of transmission power of a signal of its own apparatus based on the information regarding spatial reuse received from an apparatus in the BSS other than that of the own apparatus. Then, the PSR-based SR is a technique for reusing a wireless resource by transmitting a signal during a period in which the apparatus participating in the other network transmits an uplink signal, if transmission is possible.

For example, in a case where the communication apparatus 104 recognizes that uplink communication is performed in the other BSS, it usually cannot transmit a signal of its own apparatus. However, the communication apparatus 104 according to the present exemplary embodiment is equipped with a spatial reuse technique. Thus, the communication apparatus 104 can select to transmit the signal of its own apparatus in a period in which the other BSS performs uplink communication. Accordingly, the wireless resource can be reused, and communication efficiency is improved.

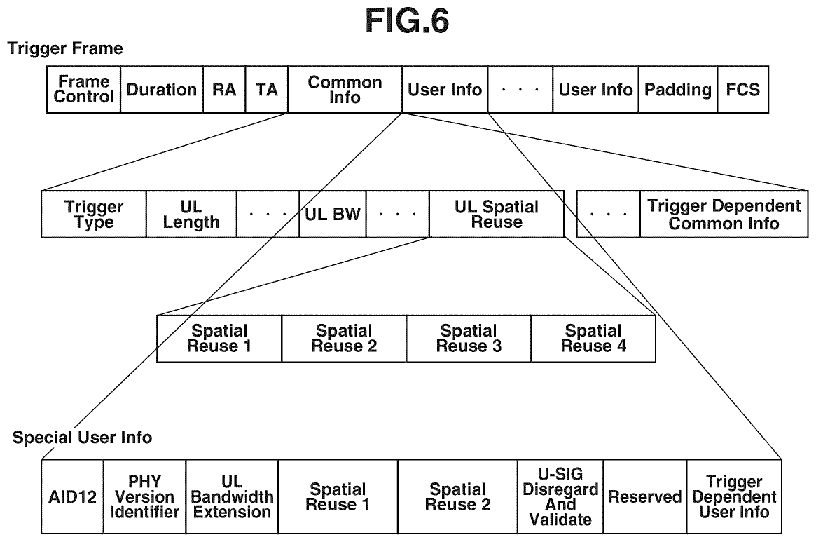

FIG. 6 illustrates an example of a configuration of a TF transmitted by the communication apparatus 102 according to the present exemplary embodiment.

A TF is a control signal that prompts another apparatus that belongs to a network formed by an apparatus transmitting the TF to transmit a signal to the apparatus transmitting the TF. A common info field of the present TF includes a UL spatial reuse subfield. Further, the UL spatial reuse subfield includes a spatial reuse 1 subfield, a spatial reuse 2 subfield, a spatial reuse 3 subfield, and a spatial reuse 4 subfield that can include the information regarding spatial reuse. Furthermore, the subfields of the spatial reuse 1, 2, 3, and 4 are each 4 bits.

In this way, the communication apparatus 102 can notify the other communication apparatus of the information regarding spatial reuse using each subfield of the spatial reuse 1, 2, 3, and 4.

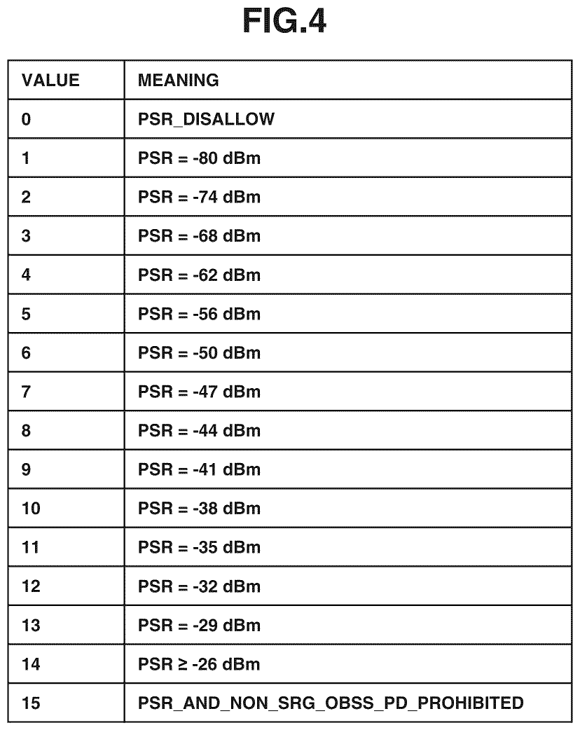

FIG. 4 illustrates information corresponding to a value of each subfield of the spatial reuse 1, 2, 3, and 4.

If the value of the subfield is 0, it means PSR_DISALLOW, which means that PSR-based spatial reuse is prohibited. If the value of the subfield is 15, it means PSR_AND_NON_SRG_OBSS_PD_PROHIBITED, which means that PSR-based and OBSS PD-based spatial reuse are prohibited. If the value of the subfield is 1 to 14, each apparatus that executes PSR-based spatial reuse determines the upper limit of the transmission power based on the PSR value indicated by the subfield.

The present TF also includes a special user info field illustrated in FIG. 6. The special user info field is a user info field in which an AID12 subfield includes a value 2007. The special user info field includes an HR spatial reuse 1 subfield and an HR spatial reuse 2 subfield. The subfields of the HR spatial reuse 1 and 2 are each 4 bits and can include the information regarding spatial reuse. FIG. 4 also illustrates information corresponding to a value of each subfield of the HR spatial reuse 1 and 2.

The subfields of the HR spatial reuse 1 and 2 correspond to subbands of the bandwidth used in communication between the communication apparatus 102 and the communication apparatus 103. For example, in a case where a bandwidth of 80 MHz is used in communication between the communication apparatus 102 and the communication apparatus 103, the subfields of the HR spatial reuse 1 and 2 each correspond to 40 MHz subbands.

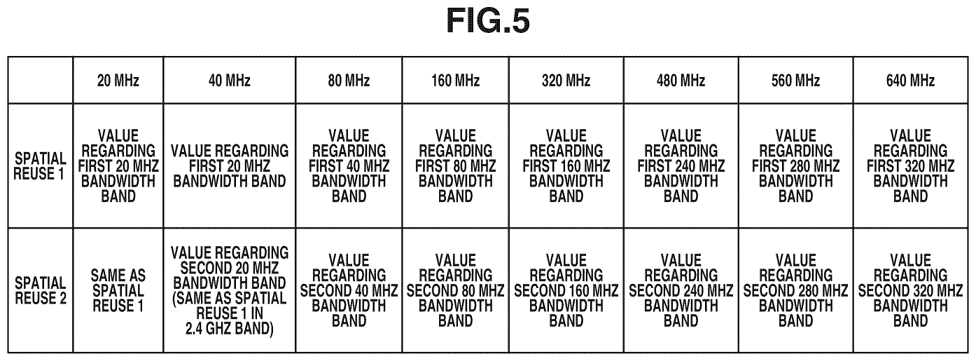

A relationship between the subfields of the HR spatial reuse 1 and 2 and the subbands is equivalent to a relationship between the subfields of the spatial reuse 1 and 2 and the subbands illustrated in FIG. 5.

For example, in a case where a used bandwidth is a bandwidth of 20 MHZ, the HR spatial reuse 1 subfield indicates the information regarding spatial reuse in a first 20 MHz subband. Further, the HR spatial reuse 2 subfield includes the same value as that in the spatial reuse 1 subfield.

In a case where the used bandwidth is a bandwidth of 40 MHZ, the HR spatial reuse 1 subfield indicates the information regarding spatial reuse in the first 20 MHz subband. Further, the HR spatial reuse 2 subfield indicates the information regarding spatial reuse in a second 20 MHz subband. However, if the frequency band being used is the 2.4 GHz band, the same value as the HR spatial reuse 1 subfield is entered.

In a case where the used bandwidth is the bandwidth of 80 MHz, the HR spatial reuse 1 subfield indicates the information regarding spatial reuse in a first 40 MHz subband. Further, the HR spatial reuse 2 subfield indicates the information regarding spatial reuse in a second 40 MHz subband.

In a case where the used bandwidth is a bandwidth of 160 MHz, the HR spatial reuse 1 subfield indicates the information regarding spatial reuse in a first 80 MHz subband. Further, the HR spatial reuse 2 subfield indicates the information regarding spatial reuse in a second 80 MHz subband.

In a case where the used bandwidth is a bandwidth of 320 MHz, the HR spatial reuse 1 subfield indicates the information regarding spatial reuse in a first 160 MHz subband. Further, the HR spatial reuse 2 subfield indicates the information regarding spatial reuse in a second 160 MHz subband.

In a case where the used bandwidth is a bandwidth of 480 MHz, the HR spatial reuse 1 subfield indicates the information regarding spatial reuse in a first 240 MHz subband. Further, the HR spatial reuse 2 subfield indicates the information regarding spatial reuse in a second 240 MHz subband.

In a case where the used bandwidth is a bandwidth of 560 MHz, the HR spatial reuse 1 subfield indicates the information regarding spatial reuse in a first 280 MHz subband. Further, the HR spatial reuse 2 subfield indicates the information regarding spatial reuse in a second 280 MHz subband.

In a case where the used bandwidth is a bandwidth of 640 MHZ, the HR spatial reuse 1 subfield indicates the information regarding spatial reuse in a first 320 MHz subband. Further, the HR spatial reuse 2 subfield indicates the information regarding spatial reuse in a second 320 MHz subband.

In this way, the communication apparatus 102 can notify the other communication apparatus of the information regarding spatial reuse using each subfield of the HR spatial reuse 1 and 2.

As described above, the communication apparatus 102, which is the AP, can input values 1 to 14 in the fields of the spatial reuse 1 to 4 and the subfields of the HR spatial reuse 1 and 2 of the TF in transmitting the PSRR PPDU. The values 1 to 14 indicate the PSR values as illustrated in FIG. 4. Further, the communication apparatus 102 acquires the PSR value based on the transmission power of the PSRR PPDU that transmits the TF, expected reception power of the TB PPDU to be received, and an expected packet error rate of the TB PPDU. Then, based on the acquired PSR value and FIG. 4, the communication apparatus 102 selects the values 1 to 14 to be included in the fields of the spatial reuse 1 to 4 and the subfields of the HR spatial reuse 1 and 2 of the TF to be transmitted.

Next, the communication apparatus 103 that has received the TF from the communication apparatus 102 communicates the HR TB PPDU. The HR TB PPDU is a signal transmitted by the communication apparatus 103 that receives the trigger frame transmitted from the communication apparatus 102, which is the AP, and participates in the network configured by the communication apparatus 102. The HR TB PPDU is used to be transmitted as a response to the trigger frame.

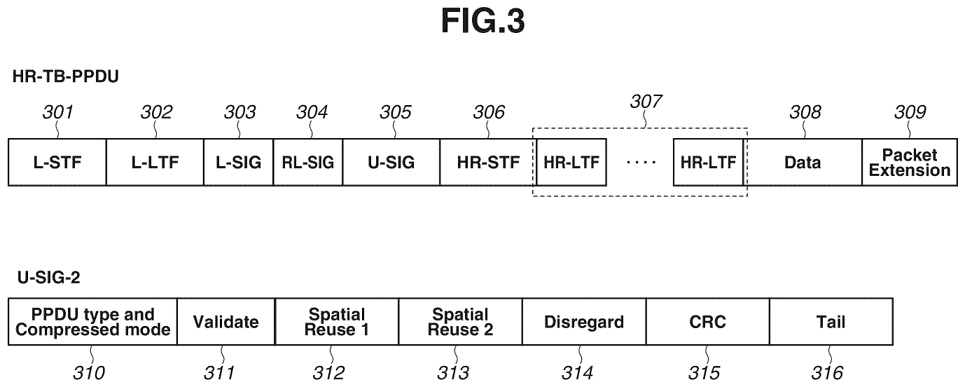

FIG. 3 illustrates an example of a PHY frame structure of an HR TB PPDU transmitted by the communication apparatus 103 according to the present exemplary embodiment.

The present frame includes a legacy short training field (L-STF) 301, a legacy long training field (L-LTF) 302, a legacy signal (L-SIG) 303, a repeated legacy signal (RL-SIG) 304, a universal signal (U-SIG) 305, a high reliability STF (HR-STF) 306, and an HR-LTF 307 from the beginning. Further, the HR-LTF 307 is followed by a data field 308 and a packet extension 309. The order of each field in the HR TB PPDU is not limited to this.

The L-STF 301, the L-LTF 302, and the L-SIG 303 are backward compatible with the IEEE 802.11a/b/g/n/ac/ax/be standards, which are legacy standards formulated prior to the IEEE 802.11 HR standard. In other words, the L-STF 301, the L-LTF 302, and the L-SIG 303 are legacy fields that can be decoded by the communication apparatus conforming to the IEEE 802.11 series standards prior to the IEEE 802.11be standard.

The L-STF 301 is used for detection of a wireless packet signal, automatic gain control (AGC), timing detection, and the like. The L-LTF 302 is used for high precision frequency and time synchronization and acquisition of propagation channel information (channel state information (CSI)). The L-SIG 303 is used to transmit control information including information about a data transmission rate and a packet length. The RL-SIG is used to identify that the standard is a standard after the IEEE 802.11ac standard. The RL-SIG 304 may be omitted.

The HR-STF 306 and the HR-LTF 307 are fields that can be decoded by the communication apparatus conforming to the IEEE 802.11 HR standard.

The L-STF 301, the L-LTF 302, the L-SIG 303, the RL-SIG 304, the U-SIG 305, the HR-STF 306, and the HR-LTF 307 are collectively referred to as PHY preambles.

The U-SIG 305 is divided into two fields: a U-SIG-1 field and a U-SIG-2 field.

The U-SIG-1 field includes subfields indicated in Table 1.

TABLE 1

| Bit | | Bit | |
|---|---|---|---|
| Position | Subfield | Number | Description |
| B0-B2 | PHY Version | 3 | Distinguish between PHY versions |
| | Identifier | | |
| B3-B5 | Bandwidth | 3 | Indicate bandwidth used in |
| | | | communication |
| B6 | UL/DL | 1 | Indicate whether UL or DL |
| B7-B12 | BSS Color | 6 | Identifier of BSS |
| B13-B19 | TXOP | 7 | Indicate NAV setting and TXOP |
| | | | protection period information |
| B20-B25 | Disregard | 6 | Reservation |

The U-SIG-2 field includes subfields indicated in Table 2.

TABLE 2

| Bit | | Bit | |
|---|---|---|---|
| Position | Subfield | Number | Description |
| B0-B1 | PPDU Type And | 2 | 0 (zero) in case of TB PPDU |
| | Compressed Mode | | |
| B2 | Validate | 1 | Reservation |
| B3-B6 | Spatial Reuse 1 | 4 | Indicate information regarding |
| | | | Spatial Reuse |
| B7-B10 | Spatial Reuse 2 | 4 | Indicate information regarding |
| | | | Spatial Reuse |
| B11-B15 | Disregard | 5 | Reservation |
| B16-B19 | CRC | 4 | CRC |
| B20-B25 | Tail | 6 | Indicate end |

The communication apparatus 103 indicates the information regarding spatial reuse using each subfield of the spatial reuse 1 and 2.

FIG. 4 illustrates meanings corresponding to the values in each subfield of the spatial reuse 1 and 2.

If the value of the subfield is 0, it means PSR_DISALLOW, which means that PSR-based spatial reuse is prohibited. If the value of the subfield is 15, it means PSR_AND_NON_SRG_OBSS_PD_PROHIBITED, which means that PSR-based and OBSS PD-based spatial reuse are prohibited. If the value of the subfield is 1 to 14, each apparatus that executes PSR-based spatial reuse determines the upper limit of the transmission power based on the PSR value indicated by the subfield.

The subfields of the spatial reuse 1 and 2 correspond to the subbands of the bandwidth used in communication between the communication apparatus 102 and the communication apparatus 103. For example, in a case where the bandwidth of 80 MHz is used in communication between the communication apparatus 102 and the communication apparatus 103, the subfields of the spatial reuse 1 and 2 each correspond to 40 MHz subbands.

FIG. 5 illustrates the relationship between the subfields of the spatial reuse 1 and 2 and the subbands for each of the used bandwidths.

In a case where the used bandwidth is the bandwidth of 20 MHz, the spatial reuse 1 subfield indicates the information regarding spatial reuse in the first 20 MHz subband. Further, the spatial reuse 2 subfield includes the same value as that in the spatial reuse 1 subfield.

In a case where the used bandwidth is the bandwidth of 40 MHZ, the spatial reuse 1 subfield indicates the information regarding spatial reuse in the first 20 MHz subband. Further, the spatial reuse 2 subfield indicates the information regarding spatial reuse in the second 20 MHz subband. However, if the frequency band being used is the 2.4 GHz band, the same value as the spatial reuse 1 subfield is entered.

In a case where the used bandwidth is the bandwidth of 80 MHZ, the spatial reuse 1 subfield indicates the information regarding spatial reuse in the first 40 MHz subband. Further, the spatial reuse 2 subfield indicates the information regarding spatial reuse in the second 40 MHz subband.

In a case where the used bandwidth is the bandwidth of 160 MHz, the spatial reuse 1 subfield indicates the information regarding spatial reuse in the first 80 MHz subband. Further, the spatial reuse 2 subfield indicates the information regarding spatial reuse in the second 80 MHz subband.

In a case where the used bandwidth is the bandwidth of 320 MHz, the spatial reuse 1 subfield indicates the information regarding spatial reuse in the first 160 MHz subband. Further, the spatial reuse 2 subfield indicates the information regarding spatial reuse in the second 160 MHz subband.

In a case where the used bandwidth is the bandwidth of 480 MHz, the spatial reuse 1 subfield indicates the information regarding spatial reuse in the first 240 MHz subband. Further, the spatial reuse 2 subfield indicates the information regarding spatial reuse in the second 240 MHz subband.

In a case where the used bandwidth is the bandwidth of 560 MHz, the spatial reuse 1 subfield indicates the information regarding spatial reuse in the first 280 MHz subband. Further, the spatial reuse 2 subfield indicates the information regarding spatial reuse in the second 280 MHz subband.

In a case where the used bandwidth is the bandwidth of 640 MHZ, the spatial reuse 1 subfield indicates the information regarding spatial reuse in the first 320 MHz subband. Further, the spatial reuse 2 subfield indicates the information regarding spatial reuse in the second 320 MHz subband.

In this way, the communication apparatus 103, which is the STA, generates and transmits the HR TB PPDU including the information regarding spatial reuse and thus can notify the other communication apparatus of the information regarding spatial reuse.

Further, the communication apparatus 104, which is the AP, receives the HR TB PPDU including the subfields of the spatial reuse 1 and 2 from the communication apparatus 103 and thus can acquire information regarding the use of spatial reuse of the communication apparatus 103.

The subfields of the spatial reuse 1 and 2 are fields included in the HR TB PPDU and are not included in other PPDUs. Specifically, the subfields of the spatial reuse 1 and 2 are not included in the HR MU PPDU, which is communicated in executing MU communication.

According to the present exemplary embodiment, it is described that a PHY frame of the HR TB PPDU includes a legacy field that can be decoded by the communication apparatus conforming to the IEEE 802.11 series standards prior to the IEEE 802.11be standard, but the present invention is not limited to this. Specifically, the PHY frame of the HR TB PPDU may be configured not to include the L-STF, the L-LTF, the L-SIG, and the RL-SIG. In this case, the PHY frame of the HR TB PPDU may be configured with the HR-STF, the HR-LTF, the U-SIG, the HR-LTF, the data field, and the packet extension from the beginning. The HR-LTF following the U-SIG field may be omitted. For example, in a case where the communication apparatus 103 performs communication in the 6 GHz band, the communication apparatus conforming to only standards prior to the IEEE 802.11ax standard does not receive a signal, so that communication may be performed using the HR TB PPDU that does not include a legacy field.

The name of each field, bit positions, and the number of bits used in the present exemplary embodiment are not limited to those described in the present exemplary embodiment, and similar information may be stored in a PHY frame with a different field name, a different position, and different number of bits.

The standard name such as IEEE 802.11 HR and descriptions of character string portions corresponding to the standard names that include field names including the same character strings as the standard names typified by HR-SIG, HR-STF, HR-LTF, HR-SIG MCS, and HR spatial reuse, are not limited to this. For example, it may be high reliability (HRL). It may also be high reliability wireless (HRW). It may also be very high reliability (VHR). It may also be extremely high reliability (EHR).

It may also be ultra high reliability (UHR). It may also be low latency (LL). It may also be very low latency (VLL). It may also be extremely low latency (ELL). It may also be ultra low latency (ULL). It may also be high reliable and low latency (HRLL). It may also be ultra-reliable and low latency (URLL). It may also be ultra-reliable and low latency communications (URLLC). It may also be other different names. For example, if UHR is used, a field name will also imitate the standard and be a character string corresponding to the standard name, such as UHR-SIG, UHR-STF, UHR-LTF, and UHR-SIG MCS.

The exemplary embodiments are described in detail above, but the present invention can be implemented as, for example, a system, an apparatus, a method, a program, or a recording medium (storage medium). Specifically, the present invention may be applied to a system configured with a plurality of devices (for example, a host computer, an interface device, an image capturing apparatus, and a web application) or may be applied to an apparatus configured with a single device.

The present invention can also be realized by processing of supplying a program for realizing one or more functions of the above-described exemplary embodiments to a system or an apparatus via a network or a storage medium and having one or more processors in a computer of the system or the apparatus read and execute the program. Further, the present invention can also be realized by a circuit (e.g., an application specific integrated circuit (ASIC)) that realizes one or more functions.

The present invention is not limited to the above-described exemplary embodiments, and various modifications and changes can be made without departing from the spirit and the scope of the present invention. Therefore, the following claims are attached in order to publicize the scope of the present invention.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present invention, a communication apparatus that can communicate using a wider bandwidth is able to appropriately communicate information regarding spatial reuse.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A communication apparatus comprising:
a transmission unit configured to transmit a trigger-based (TB) physical layer protocol data unit (PPDU) including:
a legacy-short training field (L-STF);
a legacy-long training field (L-LTF) following the L-STF;
a legacy-signal (L-SIG) following the L-LTF;
a universal signal (U-SIG) which is a field following the L-SIG and includes a spatial reuse 1 subfield and a spatial reuse 2 subfield, and in which in a case where the communication apparatus uses a bandwidth of 640 MHz, the spatial reuse 1 subfield indicates information regarding spatial reuse in a first 320 MHz subband and the spatial reuse 2 subfield indicates information regarding spatial reuse in a second 320 MHz subband;
a second short training field (STF) following the U-SIG; and
a second long training field (LTF) following the second STF.

2. The communication apparatus according to claim 1, wherein the transmission unit includes an antenna that is used for transmission of the TB PPDU.

3. The communication apparatus according to claim 1, further comprising a reception unit configured to receive a trigger frame from another communication apparatus,
wherein, in a case where the trigger frame is received from the reception unit, the transmission unit transmits the TB PPDU to the another communication apparatus.

4. The communication apparatus according to claim 1, wherein, in a case where a PPDU different from the TB PPDU is transmitted, the transmission unit transmits a PPDU that does not include the spatial reuse 1 and the spatial reuse 2.

5. The communication apparatus according to claim 1, wherein the transmission unit transmits an extremely high throughput (EHT) TB PPDU conforming to the Institute of Electrical and Electronics Engineers (IEEE) 802.11 EHT standard.

6. A method for controlling a communication apparatus, the method comprising transmitting a TB PPDU including:
an L-STF;
an L-LTF following the L-STF;
an L-SIG following the L-LTF;
a U-SIG which is a field following the L-SIG and includes a spatial reuse 1 subfield and a spatial reuse 2 subfield, and in which in a case where the communication apparatus uses a bandwidth of 640 MHz, the spatial reuse 1 subfield indicates information regarding spatial reuse in a first 320 MHz subband and the spatial reuse 2 subfield indicates information regarding spatial reuse in a second 320 MHz subband;
a second STF following the U-SIG; and
a second LTF following the second STF.

7. A non-transitory computer-readable storage medium storing instructions that, when executed by a computer, cause the computer to perform a method for controlling a communication apparatus, the method comprising transmitting a TB PPDU including:
an L-STF;
an L-LTF following the L-STF;
an L-SIG following the L-LTF;
a U-SIG which is a field following the L-SIG and includes a spatial reuse 1 subfield and a spatial reuse 2 subfield, and in which in a case where the communication apparatus uses a bandwidth of 640 MHz, the spatial reuse 1 subfield indicates information regarding spatial reuse in a first 320 MHz subband and the spatial reuse 2 subfield indicates information regarding spatial reuse in a second 320 MHz subband;
a second STF following the U-SIG; and
a second LTF following the second STF.
